(19) United States
(12) Patent Application Publication
(10) Pub. No.: US 2013/0227296 A1
(43) Pub. Date: Aug. 29, 2013

(54) VIRTUAL MACHINE OPERATION SECURITY SYSTEM AND METHOD

(71) Applicant: HON HAI PRECISION INDUSTRY CO., LTD., (US)

(72) Inventors: CHUNG-I LEE, New Taipei (TW); CHIEN-FA YEH, New Taipei (TW); KUAN-CHIAO PENG, New Taipei (TW); YEN-HUNG LIN, New Taipei (TW)

(73) Assignee: HON HAI PRECISION INDUSTRY CO., LTD., New Taipei (TW)

(21) Appl. No.: 13/751,067

(22) Filed: Jan. 26, 2013

(30) Foreign Application Priority Data
Feb. 23, 2012 (TW) 101106035

(51) Int. Cl. H04L 9/32; G06F 1/26

(52) U.S. Cl. CPC H04L 9/3281; G06F 1/26
USPC 713/176

(57) ABSTRACT

In a virtual machine (VM) operation security method, a control computer generates an asymmetric key pair that include a private key and a public key for a client computer. The public key is stored in a first storage system of the control computer and the asymmetric key pair are stored to a second storage system of a client computer. The client computer electronically signs a specific parameter of a VM in the control computer using the private key, and generates an instruction of performing an operation to the virtual machine. The control computer receives the instruction, verifies the electronically signed specific parameter in the instruction, and performs the operation to the virtual machine according to a verification result.

### BACKGROUND

1. Technical Field

Embodiments of the present disclosure relate to virtual machine technology, and particularly to a virtual machine operation security system and method.

2. Description of Related Art

A physical machine such as a server, may have a plurality of virtual machines (VMs) installed for providing multiple services to users. When a user is granted access to the physical machine or to the host of the virtual machines, the user may also have access to the virtual machines without being specifically granted access to these virtual machines. Thus, the virtual machine security is compromised. Therefore, a virtual machine operation security system and method is needed.

### BRIEF DESCRIPTION OF THE DRAWINGS

FIG. 1 is one embodiment of a virtual machine (VM) operation security system.

FIG. 2 is a block diagram of one embodiment of function modules of a first VM operation security unit in FIG. 1.

FIG. 3 is a block diagram of one embodiment of function modules of a second VM operation security unit in FIG. 1.

FIG. 4 is a flowchart of one embodiment of a VM operation security method using the VM operation security system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

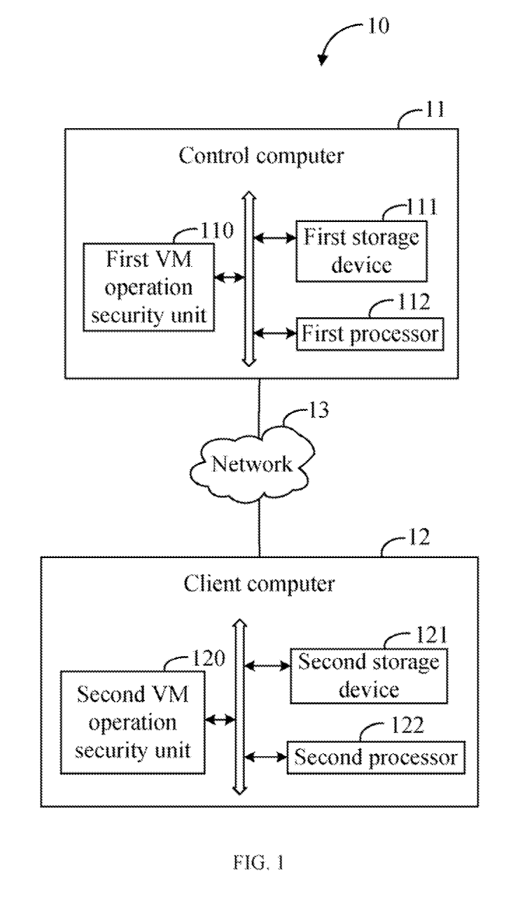

FIG. 1 is a block diagram of one embodiment of a virtual machine (VM) operation security system 10. The VM operation security system 10 includes a control computer 11 and one or more client computers 12. In the embodiment, FIG. 1 shows only one client computer 12. The control computer 11 is connected to the client computer 12 through a network 13. A plurality of virtual machines (not shown) are installed in the control computer 11. The VM operation security system 10 grants authorization to users and ensures that only authorized users operate the virtual machines. The network 13 may be the a public or private network.

In this embodiment, the control computer 11 includes a first VM operation security unit 110, a first storage system 111, and a first processor 112. The client computer 12 includes a second VM operation security unit 120, a second storage system 121, and a second processor 122. The first storage system 111 and the second storage system 121 may be dedicated memories, such as EPROMs, hard disk drives (HDDs), or flash memories. In some embodiments, the first storage system 111 and the second storage system 121 may be external storage devices, such as external hard disks, storage cards, or data storage mediums.

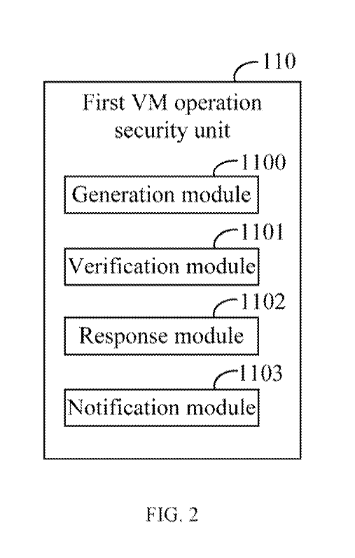

FIG. 2 is a block diagram of one embodiment of function modules of the first VM operation security unit 110 in FIG. 1. The first VM operation security unit 110 may include a generation module 1100, a verification module 1101, a response module 1102, and a notification module 1103. The modules 1100-1103 may comprise computerized code in the form of one or more programs that are stored in the first storage system 111.

The computerized code includes instructions that are executed by the first processor 112.

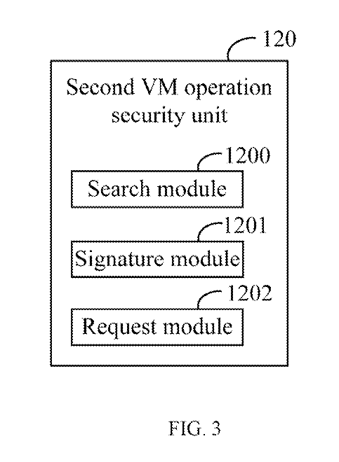

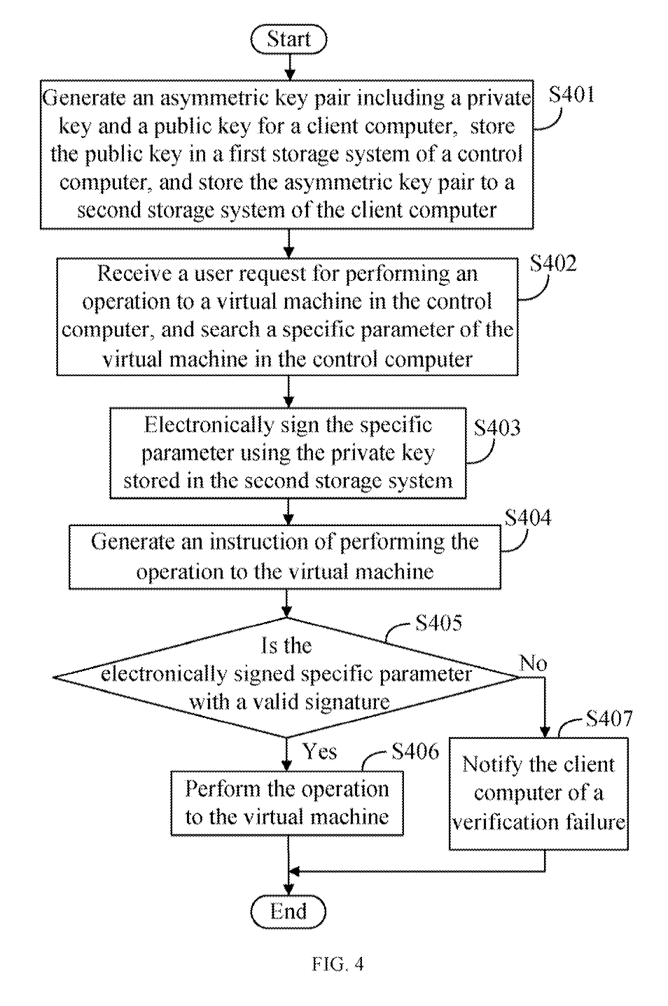

FIG. 3 is a block diagram of one embodiment of function modules of the second VM operation security unit 120 in FIG. 1. The second VM operation security unit 120 may include a search module 1200, a signature module 1201, and a request module 1202. The modules 1200-1202 may comprise computerized code in the form of one or more programs that are stored in the second storage system 121. The computerized code includes instructions that are executed by the second processor 122. A description of the functions of the modules 1100-1103 and 1200-1202 is given in reference to FIG. 4.

FIG. 4 is a flowchart of one embodiment of a VM operation security method using the system 10 of FIG. 1. Depending on the embodiment, additional steps may be added, others removed, and the ordering of the steps may be changed.

In step S401, the generation module 1100 generates an asymmetric key pair, which include a private key and a public key, for each of the client computers 12. The generation module 110 stores the public key in the first storage system 111, and stores the asymmetric key pair to the second storage system 121 of the corresponding client computer 12. In one embodiment, the asymmetric key pair are RSA asymmetric keys.

In step S402, the search module 1200 receives a user request for performing an operation to a virtual machine in the control computer 11, and searches a specific parameter of the virtual machine in the control computer 11. In one embodiment, the specific parameter of the virtual machine may be a universally unique identifier (UUID). The UUID of the virtual machine determines a physical address of the virtual machine and a configuration file of the virtual machine. In one example, three virtual machines denoted as VM1, VM2, and VM3 are installed in the control computer 11. A UUID of the virtual machine VM1 is represented as umUUID1. A UUID of the virtual machine VM2 is represented as umUUID2. A UUID of the virtual machine VM3 is represented as umUUID3. The UUIDS of the virtual machines may be pre-stored in a system configuration file of a system management basic input/output system (SMBIOS) of the control computer 11. The operation to the virtual machine may be a power-on operation, a power-off operation, a power-suspend operation, or a power-resume operation.

In step S403, the signature module 1201 electronically signs the specific parameter of the virtual machine using the private key stored in the second storage system 121 of the client computer 12. After the specific parameter of the virtual machine is signed electronically, an electronic signature is added to the specific parameter. In one embodiment, the signature module 1201 electronically signs the specific parameter of the virtual machine using RSA encryption algorithm.

In step S404, the request module 1202 generates an instruction of performing the operation to the virtual machine and sends the instruction to the control computer 11. The instruction includes the electronically signed specific parameter. For example, the request module 1202 generates an instruction PowerOnVM_Task(vCenterIP, Signx(vmUuid2), “on”) to power on the virtual machine VM2, where vCenterIP is an IP address of the control computer 11, Signx(vmUuid2) is the electronically signed UUID of the virtual machine VM2.

In step S405, the verification module 1101 receives the instruction with the electronically signed specific parameter from the client computer 12, retrieves the public key that is paired with the private key of the client computer 12 from the first storage system 111, and verifies whether the electronically signed specific parameter is with a valid signature using the retrieved public key. For example, the verification module 1101 verifies the electronically signed UUID of the virtual machine VM2 using the public key that is paired with the private key of the client computer 12 stored in the first storage system 111.

If the electronically signed specific parameter is with the valid signature, in step S406, the response module 1102 performs the operation to the virtual machine according to the instruction. For example, if the client computer 12 requests to perform a power-on operation to the virtual machine, the response module 1102 powers on the virtual machine.

If the electronically signed specific parameter is not with the valid signature, in step S407, the notification module 1103 notifies the client computer 12 of a verification failure. In some embodiment, the process may end if the electronically signed specific parameter is not with the valid signature.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A virtual machine operation security method being executed by a processor of a control computer, the method comprising:
generating an asymmetric key pair that comprise a private key and a public key for a client computer, storing the public key in a first storage system of the control computer, and storing the asymmetric key pair to a second storage system of the client computer connected to the control computer;
receiving an instruction of performing an operation to a virtual machine in the control computer sent from the client computer, wherein the instruction comprises a specific parameter electronically signed by the client computer using the private key of the client computer stored in the second storage system;
retrieving the public key that is paired with the private key of the client computer from the first storage system, and verifying whether the electronically signed specific parameter is with a valid signature using the retrieved public key; and
performing the operation to the virtual machine according to the instruction in response that the electronically signed specific parameter is with the valid signature.

2. The method of claim 1, further comprising:
notifying the client computer of a verification failure in response that the electronically signed specific parameter is not with the valid signature.

3. The method of claim 1, wherein the specific parameter is a universally unique identifier (UUID).

4. The method of claim 1, wherein the operation to the virtual machine is a power-on operation, a power-off operation, a power-suspend operation, or a power-resume operation.

5. The method of claim 1, wherein the asymmetric key pair are RSA asymmetric keys.

6. A virtual machine operation security method being executed by a processor of a client computer, the method comprising:
receiving a user request for performing an operation to a virtual machine in a control computer connected to the client computer, and searching a specific parameter of the virtual machine in the control computer;
electronically signing the specific parameter of the virtual machine using a private key of the client computer stored in a second storage system of the client computer, wherein the private key is generated by the control computer and is paired with a public key stored in the control computer; and
generating an instruction of performing the operation to the virtual machine and sending the instruction to the control computer, wherein the instruction comprises the electronically signed specific parameter.

7. The method of claim 6, wherein the specific parameter is a universally unique identifier (UUID).

8. The method of claim 6, wherein the operation to the virtual machine is a power-on operation, a power-off operation, a power-suspend operation, or a power-resume operation.

9. The method of claim 6, wherein the private key is an RSA asymmetric key.

10. A control computer, comprising:
a first storage system;
at least one processor; and
a first virtual machine operation security unit comprising one or more programs that are stored in the first storage system and executed by the at least one processor, the one or more programs comprising instructions to:
generate an asymmetric key pair that comprise a private key and a public key for a client computer connected to the control computer, store the public key in the first storage system, and store the asymmetric key pair to a second storage system of the client computer;
receive an instruction of performing an operation to a virtual machine in the control computer sent from the client computer, wherein the instruction comprises a specific parameter electronically signed by the client computer using the private key of the client computer stored in the second storage system;
retrieve the public key that is paired with the private key of the client computer from the first storage system, and verify whether the electronically signed specific parameter is with a valid signature using the retrieved public key; and
perform the operation to the virtual machine according to the instruction in response that the electronically signed specific parameter is with the valid signature.

11. The control computer of claim 10, wherein the one or more programs further comprise instructions to:
notify the client computer of a verification failure in response that the electronically signed specific parameter is not with the valid signature.

12. The control computer of claim 10, wherein the specific parameter is a universally unique identifier (UUID).

13. The control computer of claim 10, wherein the operation to the virtual machine is a power-on operation, a power-off operation, a power-suspend operation, or a power-resume operation.

14. The control computer of claim 10, wherein the asymmetric key pair are RSA asymmetric keys.
